(19) United States
(12) Patent Application Publication
(10) Pub. No.: US 2012/0025083 A1
(43) Pub. Date: Feb. 2, 2012

(54) Space-based CT scan system toward an astronomical object

(76) Inventor: Tomohiro Tsuta, Kobe (JP)

(21) Appl. No.: 13/200,495

(22) Filed: Sep. 26, 2011

(30) Foreign Application Priority Data
Oct. 6, 2010 (JP) 2010-240142

(51) Int. Cl. G01N 23/04

(52) U.S. Cl. 250/360.1

(57) ABSTRACT

A CT scan system toward an astronomical object, including: a first satellite means for equipping a first satellite with an emitting means, said emitting means being for emitting super penetrating elementary particles; a second satellite means for equipping a second satellite with a detection means, said detection means being for detecting said super penetrating elementary particles; a super penetrating elementary particle measurement means for measuring the super penetrating elementary particles that are emitted from said emitting means, transmitted through said astronomical object, and detected by said detection means on said second satellite, said second satellite being, at the time of a measurement, opposite to said first satellite with respect to said astronomical object in between; and a CT reconstructing means for reconstructing a CT scan image regarding internal structure of said astronomical object based on the data obtained from said super penetrating elementary particle measurement means iterated.

### BACKGROUND OF THE INVENTION

The present invention relates to a CT (Computed Tomography) system toward an astronomical object using super penetrating elementary particles.

There is no system which intends to carry out CT (Computed Tomography) or CT (Computed Tomography) scan toward an astronomical object using super penetrating elementary particles.
Nonpatent literature 1: “The latest comprehensive dictionary of medical science” Ishiyaku Publishers Inc., 1987, 1990.

An aim of the present invention is to provide a CT (Computed Tomography) or CT scan system toward an astronomical object using the super penetrating elementary particles whose penetrating power is extraordinarily large.

### SUMMARY OF THE INVENTION

To achieve the above aim,
the present invention is a CT scan system toward an astronomical object, including:
a first satellite means for equipping a first satellite with an emitting means, said emitting means being for emitting super penetrating elementary particles, said first satellite being placed in an orbit around said astronomical object;
a second satellite means for equipping a second satellite with a detection means, said detection means being for detecting said super penetrating elementary particles, said second satellite being placed in an orbit around said astronomical object;
a super penetrating elementary particle measurement means for measuring the super penetrating elementary particles that are emitted from said emitting means, transmitted through said astronomical object, and detected by said detection means on said second satellite, said second satellite being, at the time of a measurement, opposite to said first satellite with respect to said astronomical object in between;
   and
a CT reconstructing means for reconstructing a CT scan image regarding internal structure of said astronomical object based on the data obtained from said super penetrating elementary particle measurement means iterated.

### BRIEF DESCRIPTION OF THE DRAWINGS

FIG. 1 is a diagram showing a preferred embodiment of the present invention.

FIG. 2 is a diagram showing a preferred embodiment of the present invention.

FIG. 3 is a diagram showing a preferred embodiment of the present invention.

FIG. 4 is a diagram showing a preferred embodiment of the present invention.

FIG. 5 is a diagram showing a preferred embodiment of the present invention.

### DETAILED DESCRIPTION OF THE INVENTION

The super penetrating elementary particles in the present invention refer to elementary particles (elementary subatomic particles) with extraordinary penetrating power (such as, neutrinos, muons, novel elementary particles with extraordinary penetrating power, etc.).

The super penetrating elementary particles in the present invention may artificially be generated (as a beam) using, for example, a particle accelerator, a proton accelerator, a proton synchrotron, etc. (which may be miniaturized or micro-machined.)

For example, as is generally known, irradiating a target material (e.g., graphite, aluminum, etc.) with a proton beam from a proton synchrotron could generate a large number of mesons (e.g., pions (and kaons)), and their travelling direction could be adjusted (focused) (via e.g., electromagnetic horns (made of aluminum)) so that they may travel through a medium which causes them to decay into muons and (muon) neutrinos, and by applying a radiation shield (an absorber) to the resultant, neutrinos may be selectively emitted.

### (Such a Construction May be Miniaturized or Micro-Machined.)

(The target material and the horns may be configured to be movable with respect to each other in order to achieve various focusing of the neutrino beam, which allows the adjustability of the neutrino beam energy.)

(Or (nuclear) reactor(s) may be utilized to produce super penetrating elementary particles. (Such a construction may be miniaturized or micro-machined.))

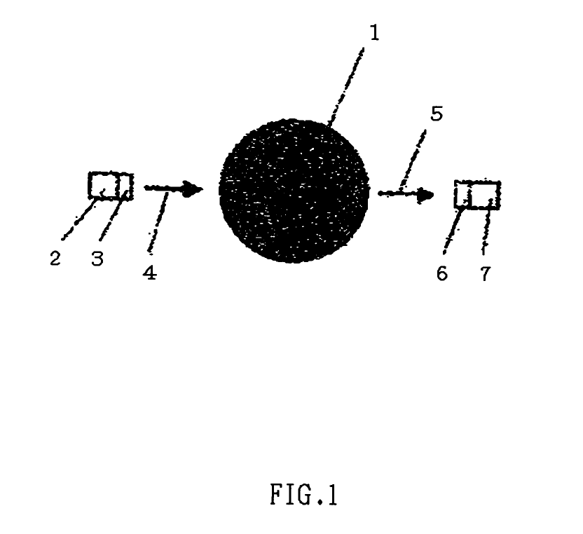

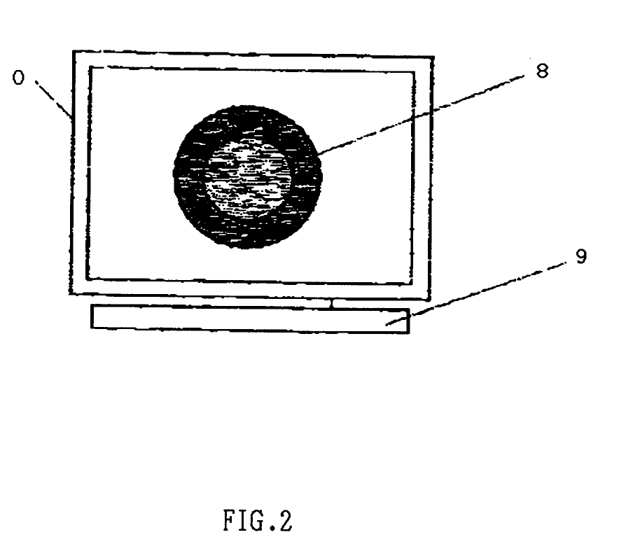

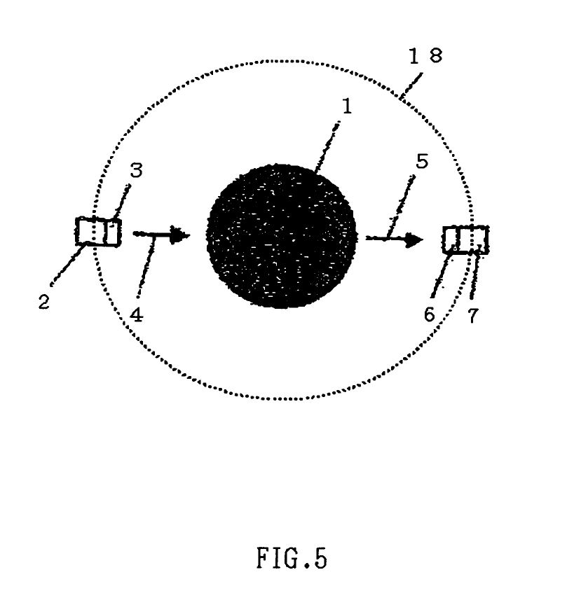

Referring to FIG. 1, FIG. 2 and FIG. 5, the present invention will be described.

The present invention is a system and method as below:

Under a positional configuration of a super penetrating elementary particle emitting device 3 onboard a first satellite 2 that orbits around an astronomical object 1, being located opposite to a super penetrating elementary particle detection device 6 onboard a second satellite 7 that orbits around the astronomical object 1, with respect to the astronomical object 1 in between,

super penetrating elementary particles 4 emitted from the first satellite 2, while a portion (fraction) of them are absorbed (or transformed) by the astronomical object 1, pass through the astronomical object 1 to reach the super penetrating elementary particle detection device 6 which detects and records them as super penetrating elementary particles transmitted through the astronomical object 5.

### (A First Satellite Means.)

### (A Second Satellite Means.)

### (A Super Penetrating Elementary Particle Measurement Means.)

(The first satellite 2 may be made of generally known (conventional) satellite construction (components).) (The second satellite 7 may be made of generally known (conventional) satellite construction (components).)
(The satellite(s) may be placed into the orbit(s) using generally known (conventional) methods.)
The orbits around the astronomical object 1 by the first satellite 2 and the second satellite 7 may either be the same or different.

### (An Orbit Around the Astronomical Object 18.)

(Or the target material (super penetrating elementary particles' origin) and the horns (focusing component) may be onboard different (but nearly positioned) satellites which orbit the astronomical object, to achieve movability with respect to each other, in order to enable various focusing and energy adjustability of the neutrino beam.)

And the present invention is a system and method as below:

The first satellite 2 and second satellite 7 carry out, as a pair (each utilizing movement (positioning) along its orbit), the similar detection measurements iteratively in multiple directions (necessary for generating a CT or CT scan image for the astronomical object 1) with respect to the astronomical object 1 in between, storing on a memory device to what degree the super penetrating elementary particles 4 have been absorbed (or transformed) by the astronomical object 1 in each direction, and the resulting data are fed into a generally known CT (Computed Tomography) algorithm (e.g., Fourier transform, etc.) to be processed (analyzed) by a CPU 9 in order to reconstruct a CT scan image of the astronomical object 8 and to display it on an output device 10.

### (A CT Reconstructing Means.)

The memory device (such as a RAM 502, a HDD 504, etc.) may be onboard the satellite (spacecraft) and/or on the ground (on a ground station).
The CPU 9 may be on the ground (on a ground station) and/or onboard the satellite (spacecraft).
The satellite(s)(, spacecraft), the earth (, ground station(s)), etc. may be interlinked with generally known means of communication (conventional telemetry).
(The memory device and the CPU 9 may be interlinked with generally known means of communication (conventional telemetry).)
The resulting data (from the satellite(s) (spacecraft)) may be, for example, downlinked to the CPU 9 on the earth (or spacecraft, etc.) (via generally known means of communication (telemetry) between the satellite, the earth (spacecraft), etc.).
(Or the CT scan processing may be carried out internally with a CPU onboard the satellite or spacecraft.)
(As is generally known, the super penetrating elementary particle detection device 6 may be configured to allow the detection of the transformation of the super penetrating elementary particles 4 (e.g., flavor oscillations of neutrinos) associated with passing through the astronomical object.)
(Deploying a plurality of such satellite pairs around the astronomical object may shorten the time for generating a CT scan image of the astronomical object.)
A LCD (Liquid Crystal Display), a CRT (Cathode Ray Tube), an OLED (Organic Light Emitting Diode) device, or the like may be used as the output device 10.
(The CPU 9 in the present invention may be configured, for example, including: a microprocessor, a RAM (Random Access Memory), a ROM (Read Only Memory), a HDD (Hard Disc Drive), a keyboard, a mouse, a display, a printer, a speaker, and a communications (telemetry) interface. These parts are connected via a bus.
The CPU 9 carries out operations for the present invention, by loading onto the RAM a program (e.g., generally known CT (Computed Tomography) algorithm), which is stored in the HDD (Hard Disc Drive), for realizing the present invention. The program for realizing the present invention can be stored on any computer-readable recording media (storage media). Examples of such recording media (storage media) are an optical disk, a magneto-optic disk (CD-ROM, DVD-RAM, DVD-ROM, MO, etc.), a magnetic-storage device (hard disk, Floppy Disk™, ZIP, etc.), a semiconductor memory, etc.)
The CT scan image of the astronomical object 8 may be image processed by the CPU 9 to be displayed three dimensionally on the output device 10 (via generally known arithmetic processing). The internal structure of the astronomical object 1 may be three dimensionally rendered by the CPU 9, based on the voxel data.
A virtual stereoscopic representation, in which a view point may be located at a position inside the astronomical object 1, may be generated by generally known arithmetic processing of the CPU 9.

The degree of absorption (or transmissivity) of the super penetrating elementary particles 4 by the astronomical object 1 may be evaluated more accurately by comparing the observation from the super penetrating elementary particle detection device 6 with the measurement from a (pre) near elementary particle detection device to be positioned near the super penetrating elementary particle emitting device 3 in order to precisely measure and take into consideration the intensity and energy distribution of the super penetrating elementary particles 4 at the time of the emission from the super penetrating elementary particle emission device 3.

An astronomical object 1 refers to, for example, each planet (including the earth), each satellite (moon), the sun, etc. in the solar system (i.e., a planetary exploration target.).

### (A Celestial Body.)

An astronomical object 1 may include an asteroid, a small celestial body, etc.

Each star, each planet, and each moon (satellite) outside the solar system may be included in an astronomical object 1.

A cosmic space that includes a plurality of astronomical objects (and/or a variety of interstellar medium) may, as a whole, be a target of the CT or CT scan (e.g., in time series (real time)) using the super penetrating elementary particles.

A neutrino beam, (some kind of elementary particles with more penetrating power compared to muons, entirely novel elementary particles) etc. may be used as the super penetrating elementary particles 4 to be emitted from the super penetrating elementary particle emitting device 3 onboard the first satellite 2 (, in order to realize the detailed visualization of the internal structure of an astronomical object (including the earth) and its convection phenomenon, etc.).

(Manned or unmanned) spacecraft (or space station), etc. may be deployed in substitution for either or both of the first satellite 2 and the second satellite 7 (for the same use as the satellite).

Water (purified from radioactive ingredients) (chloride solution, heavy water, liquid scintillator), photo multiplier tube, photoelectric transducer, water Cerenkov detector, flat panel detector (made from photoconducting material (e.g., Se, etc.)), their micro machinery, etc. may be used for the super penetrating elementary particle detection device 6.

(A super sensitive photographic plate may be used for the super penetrating elementary particle detection device 6.)

The super penetrating elementary particle detection device 6 may utilize (supersensitive) microscopical oscillation detection device, (ultrasensitive) micro displacement detection device, ultrasensitive pressure sensor, piezoelectric sensor, acoustic detector, etc. in order to detect the interaction of the detector device with the super penetrating elementary particles (e.g., microscopical vibration).

The super penetrating elementary particle detection device 6 may comprise a medium (selected from, for example, among semiconductor, gas (inert gas such as argon), isobutane, plasma, scintillator, superconductor, etc.) which could cause electricity (electric charge, electric current), luminescence, etc. when excited by the super penetrating elementary particles.

(As generally known, the super penetrating elementary particle detection device 6 may be made, for example, of alternate planes of (plastic) scintillator (e.g., polystyrene) and steel. The interaction of the (plastic) scintillator with the incoming super penetrating elementary particles may be read out with optic fibers and photomultiplier tubes. And the steel plates may be magnetized to allow for the measurement of the incoming super penetrating particle momenta.)

(The energy of) the super penetrating elementary particles 4 from the super penetrating elementary particle emitting device 3 may be modulated so as to make a characteristic oscillation or switching, which the super penetrating elementary particle detection device 6 could easily detect (discriminate from background).

The super penetrating elementary particle detection device 6 may utilize resonance phenomenon (mechanical, electromagnetic, etc.) to enhance detection sensitivity.

The super penetrating elementary particles 4 from the super penetrating elementary particle emitting device 3 may be endowed with a characteristic with which the super penetrating elementary particle detection device 6 could especially resonate.

As generally known, nuclear reaction phenomenon, a nuclear decay rate change (of a radioactive material) caused by the incoming super penetrating elementary particles, radiometric analysis, etc. may be utilized for the super penetrating elementary particle detection device 6.

(Weak interaction (weak force, weak nuclear force) phenomenon may be utilized for the super penetrating elementary particle detection device 6.)

The present invention may utilize (in order to construct an observation result image) the generally known phenomenon that, given the same thickness of an observation target, the higher its density is, the more absorbed the super penetrating elementary particles (e.g., muons) are; the lower the density, the more transmissive the super penetrating elementary particles (e.g., muons).

When using muons, etc. as the super penetrating elementary particles, the present invention may make use of the fact that when passing through an observation target the trajectories of the muons, etc. suffer (multiple) scattering (due to the Coulomb scattering by the atoms' electric charges), the degree of which depends on (the constituent) (atomic nucleus) atomic number, (electron density) material density, etc. (of the observation target) (, in order to construct an observation result image).

The super penetrating elementary particles 4 omnipresent in (cosmic) space (due to cosmic ray, etc.) or the super penetrating elementary particles 4 derived from the sun, etc. may be utilized passively instead of the super penetrating elementary particle emitting device 3.

(The super penetrating elementary particles 4 from a reactor, reactors, or the like (on the ground, in the ground, or in space) may be utilized passively in substitution for the super penetrating elementary particle emitting device 3.) (For this use, the super penetrating elementary particle emitting device 3 and the first satellite 2 may be omitted.)

(Or for this use, the super penetrating elementary particle emitting device 3 may be omitted and instead a pre elementary particle detection device may be onboard the first satellite 2, to precisely measure and take into consideration the intensity and energy distribution (direction) of the super penetrating elementary particles 4 from super penetrating elementary particle emitter at the time of incidence to the pre elementary particle detection device (, for the purpose of evaluating the degree of absorption (or transmissivity) of the super penetrating elementary particles 4 by the astronomical object 1 more accurately by comparing the observation from the super penetrating elementary particle detection device 6 with the measurement from the pre elementary particle detection device).)
(Deploying a plurality of such satellites around the astronomical object may shorten the time for generating a CT scan image of an astronomical object.)

### Another of the Present Invention is:

A super penetrating elementary particle radar device, which is characterized by generating a radar image based on the data obtained from the detection of the super penetrating elementary particles reflected by an observation target.

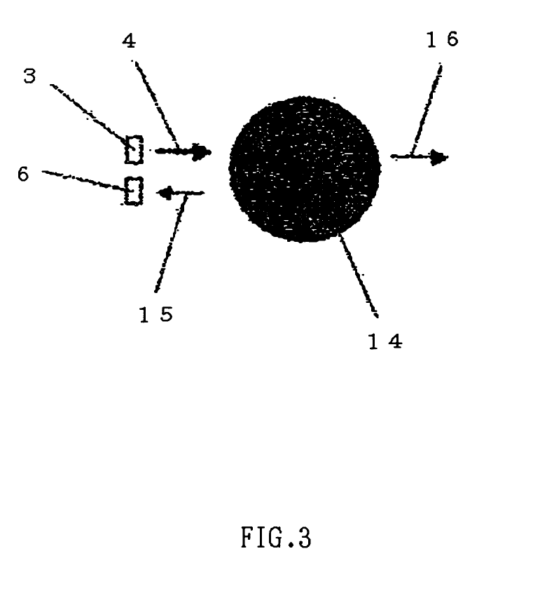

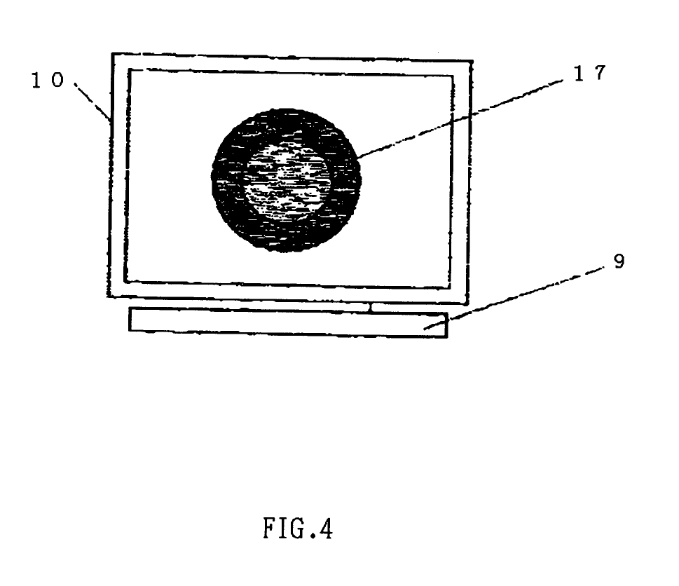

Referring to FIG. 3 and FIG. 4, the invention is described.

The invention is a radar device, which is characterized by generating a radar image based on the data obtained from the detection of the super penetrating elementary particles 15 reflected by an observation target.
The invention is a method for a super penetrating elementary particle radar device, including:

emitting super penetrating elementary particles 4 from a super penetrating elementary particle emitting device 3 to an observation target 14;

measuring and storing, as information reflecting an internal structure of said observation target 14, super penetrating elementary particles 15 reflected by said observation target 14, using a super penetrating elementary particle detection device 6 (which is positioned on the same side as said super penetrating elementary particle emitting device 3, with respect to said observation target 14 (as shown in FIG. 3)); and

visualizing (and storing) an internal structure of said observation target 14 based on said information (to be displayed by a CPU 9 on an output device 10 as a super penetrating elementary particle radar image 17).

(Said information may include temporal retardation (and dispersion) of the received signal (caused by said observation target 14) to be utilized in the visualization.)
Said super penetrating elementary particle emitting device 3 may be onboard spacecraft which orbits said observation target 14.
Said super penetrating elementary particle detection device 6 may be onboard said spacecraft or a different spacecraft which orbits said observation target 14

What is claimed is:

1. a CT scan system toward an astronomical object, comprising:
a first satellite means for equipping a first satellite with an emitting means, said emitting means being for emitting super penetrating elementary particles, said first satellite being placed in an orbit around said astronomical object;
a second satellite means for equipping a second satellite with a detection means, said detection means being for detecting said super penetrating elementary particles, said second satellite being placed in an orbit around said astronomical object;
a super penetrating elementary particle measurement means for measuring the super penetrating elementary particles that are emitted from said emitting means, transmitted through said astronomical object, and detected by said detection means on said second satellite, said second satellite being, at the time of a measurement, opposite to said first satellite with respect to said astronomical object in between; and
a CT reconstructing means for reconstructing a CT scan image regarding internal structure of said astronomical object based on the data obtained from said super penetrating elementary particle measurement means iterated.
